(19) United States
(12) Patent Application Publication
(10) Pub. No.: US 2024/0089751 A1
(43) Pub. Date: Mar. 14, 2024

(54) METHOD AND SYSTEM OF DETECTING AND MITIGATING TROPOSPHERIC INTERFERENCE

(71) Applicant: JIO PLATFORMS LIMITED, Ahmedabad (IN)

(72) Inventors: Shailesh KUMAR, Hyderabad (IN); Krusheel MUNNANGI, Bangalore (IN); Meghna PUSALA, Vizianagaram (IN); Vinit LUDHANI, Surat (IN)

(21) Appl. No.: 18/246,310

(22) PCT Filed: Jul. 28, 2022
(86) PCT No.: PCT/IB2022/056988

§ 371 Date: Mar. 22, 2023

(30) Foreign Application Priority Data
Jul. 29, 2021 (IN) 202121034068

(51) Int. Cl. H04W 24/02; H04W 16/28

(52) U.S. Cl. CPC H04W 24/02; H04W 16/28

(57) ABSTRACT

The present invention provides a method and system for predicting tropospheric interference using a digital twin model for detecting tropospheric interference and suggesting actions for mitigating the effects of the tropospheric interference. The system (110) may include a machine learning engine (216) having a digital twin model to predict/score the likelihood of cell pairs having the tropospheric interference at a given point of time using cell configuration data, weather data, Hepburn data at that point of time by identifying cell pairs whose likelihood of interference is high. The system (110) is further configured to explore the effect of changing cell configuration parameters like remote electrical tilt and identify actions that can mitigate tropospheric interference with minimal impact on coverage. The digital twin model is learned for interference using historical data of interference pairs combined with cell configuration parameters, weather parameters, and tropospheric interference data like Hepburn data.

### FIELD OF INVENTION

The embodiments of the present disclosure generally relate to communications networks. More particularly, the present disclosure relates to a method and system for automatically detecting tropospheric interference in a predictive manner and for mitigating tropospheric interference in a communication network.

### BACKGROUND OF THE INVENTION

The following description of related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of prior art.

In general, the signal quality to and from end-user devices in modern wireless communications systems is limited by interference coming from diverse sources. A wireless communication system may experience unexpected network interference originating from: intentional and unintentional radio frequency (RF) generating sources served by the same or nearby base stations, industrial machinery, and electronic test equipment radiating signals in the bands of interest. Further, interference may also be caused due to undesired mixing of signals generated by the wireless communication system, and illegal radio sources operating in the wrong frequency bands.

The presence of these interference sources results in degraded system service and reduced wireless network capacity coverage as the intentional system signals suffer degradation due to these interferers.

Tropospheric ducting can occur when warm and cold air masses lay over one another creating one or more air density interfaces that behave as low RF loss surfaces that reflect RF energy. When these conditions occur. RF signals, from a very far away from a wireless network of interest, may attain sufficiently high energy levels to degrade network receiver performance. Normally, these distant signals are sufficiently attenuated by high levels of RF path loss created by distance, RF shadowing (e.g., buildings, trees, mountains), and the curvature of the earth. As such, the signals do not measurably arrive at the distant wireless network and do not normally create interference problems in the wireless network of interest. However, tropospheric ducting can cause signals from remote sources to present problematic levels of interference energy at wireless receivers. Further, tropospheric ducting causes RF signals from remote sources to propagate over large distances, and causes interference.

There is often a long-range interference in 4G networks as well as telecommunications systems. Several cell pairs face interference and there is no way of estimating the impact of actions, like a change in remote electrical tilt (RET). There is also no way of identifying actions with minimal impact on coverage. Therefore, customer experience and capacity at victim cells are greatly reduced. One of the current methods of mitigating the interference involves increasing the guard hand at the victim cell. This approach results in a reduction in the time duration available in the uplink channel. The capacity of the uplink channel at the victim cell gets reduced, as a result of increasing the guard band at the victim cell, which is disadvantageous. Another method of mitigating the interference involves updating RET changes based on historical data: In this approach, historical information is used to identify aggressors or victims for a given day. This approach may not be able to use any predictive information like weather data and tropospheric data(Hepburn data) that is available. Further, there is no existing approach to determine the amount of tilt of an antenna for a cell pair required for mitigating tropospheric interference.

Yet another method for mitigating the tropospheric interference is changing the guard band at the aggressor cell. In this method, the guard band is increased once tropospheric interference is identified at the aggressor cell. Since the guard band increase can result in an upload capacity reduction, the guard band needs to be decreased on time. Also, guard band reduction can handle tropospheric interference from aggressors only up to a certain distance. Beyond that distance, the guard band increase fails to handle interference from aggressors. Once the guard band is increased, there is no mechanism to identify the time at which the guard band increase should be reverted, although, historical data of interference pairs is used to identify the cell pairs which have a high likelihood of interference.

These interference pairs are used to identify very aggressive aggressor cells. Tilt values are increased for these aggressive aggressor cells. Since tropospheric phenomenon is very dynamic, relying only on historical data to identify cells and take actions may not provide accurate prediction of cell pairs having interference and will not be able to identify actions on cells which will result in optimal interference mitigation.

Both the approaches may not be able to use any predicted information like weather data and tropospheric data (Hepburn data) that is available. Also, there is no approach to determine the amount of tilt to use for mitigating the interference. There are no approaches that provide a predictive capability for a cell pair having interference if weather and tropospheric information is available at the cell location at a given time in the future. Also, there is no way to identify the cell pairs which have a likelihood of interference or are causing high interference. Moreover, there is no way to suggest action for those cells such that the impact will be maximum for that action with minimal impact on coverage or to suggest a quantity of tilt values for each cell to mitigate tropospheric interference.

Thus, there is a need for an improved approach to mitigate remote tropospheric interference which will improve the customer experience and capacity at victim cells.

### OBJECT OF THE PRESENT DISCLOSURE

Some of the objects of the present disclosure, which at least one embodiment herein satisfy are as listed herein below.

It is an object of the present disclosure to provide a system and a method to preempt cells that cause long-range interference and mitigate the interference by taking actions like increasing remote electrical tilt and the like.

It is an object of the present disclosure to provide a system and a method for facilitating the learning of a digital twin model for mitigating long-range tropospheric interference.

It is an object of the present disclosure to provide a system and a method to use Hepburn data for learning the digital twin model.

It is an object of the present disclosure to provide a system and a method to use the digital twin model to predict the likelihood of tropospheric interference for a given cell pair.

It is an object of the present disclosure to provide a system and a method to evaluate different actions (changing tilt values etc.) using the digital twin model and finding an optimal set of actions that can mitigate tropospheric interference for a given cell pair.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for mitigating tropospheric interference in a communication network. The system receives a set of data packets from a first cell and a second cell in the communication network. The set of data packets comprises any or a combination of a tropospheric interference data of the one or more pairs of first cells and second cells, a strength of the tropospheric interference indicating strength of a first cell signal being received at a second cell, a date of the tropospheric interference, and a time of the tropospheric interference. Further, the system extracts a first set of attributes, a second set of attributes, and a third set of attributes of the first cell and the second cell from the received set of data packets.

The first set of attributes correspond to cell configuration data that comprises a total tilt, a remote electrical tilt (RET), a height of a cell tower, a mechanical tilt, a transmission power, and a location of a cell tower. The second set of attributes corresponds to Hepburn data that comprises a weather data index at a location of a cell tower for a given cell on a given date and a given time and Hepburn indices on the area joining first cell and second cell in a pair. The third set of attributes corresponds to weather data. Further, the system identifies one or more pairs of first cells and second cells affected by the tropospheric interference based on the extracted first set of attributes, the extracted second set of attributes, and the extracted third set of attributes.

The system computes a first edge score for the identified one or more pairs of first cells and second cells based on the extracted first set of attributes, the extracted second set of attributes, and the extracted third set of attributes. The first edge score for the identified one or more pairs of first cells and second cells indicates a likelihood of the tropospheric interference between the one or more pairs of first cells and second cells. The first edge score for the identified one or more pairs of first cells and second cells is computed by using a feature vector obtained by concatenating the first set of attributes, the second set of attributes, and the third set of attributes of the one or more pairs of first cells and second cells.

The system assigns an action to the one or more pairs of first cells and second cells based on the first edge score. The action assigned to the one or more pairs of first cells and second cells comprises a modification in a total tilt and a remote electrical tilt (RET) of an antenna for the one or more pairs of first cells and second cells. The system computes a second edge score based on the action assigned to the one or more pairs of first cells and second cells. The system calculates an impact of the action assigned to the one or more pairs of first cells and second cells based on the first edge score and a second edge score. The impact of the action assigned to the one or more pairs of first cells and second cells is the difference between the first edge score and the second edge score.

Furthermore, the system mitigates the tropospheric interference of the identified one or more pairs of first cells and second cells by configuring a total tilt and a remote electrical tilt (RET) of the antenna for the one or more pairs of first cells and second cells.

In an aspect, the present disclosure provides a method for mitigating tropospheric interference in a communication network. The method includes receiving a set of data packets from a first cell and a second cell in the communication network. The set of data packets comprises any or a combination of a tropospheric interference data of the one or more pairs of first cells and second cells, a strength of the tropospheric interference indicating strength of a first cell signal being received at a second cell, a date of the tropospheric interference, and a time of the tropospheric interference.

Further, the method includes extracting a first set of attributes, a second set of attributes, and a third set of attributes of the first cell and the second cell from the received set of data packets. The first set of attributes correspond to cell configuration data that comprises a total tilt, a remote electrical tilt (RET), a height of a cell tower, a mechanical tilt, a transmission power, and a location of a cell tower. The second set of attributes corresponds to Hepburn data that comprises a weather data index at a location of a cell tower for a given call on a given date and a given time and Hepburn indices on the area joining first cell and second cell in a pair. The third set of attributes corresponds to weather data. Further, the method includes identifying one or more pairs of first cells and second cells affected by the tropospheric interference based on the extracted first set of attributes, the extracted second set of attributes, and the extracted third set of attributes.

The method includes computing a first edge score for the identified one or more pairs of first cells and second cells based on the extracted first set of attributes, the extracted second set of attributes, and the extracted third set of attributes. The first edge score for the identified one or more pairs of first cells and second cells indicates a likelihood of the tropospheric interference between the one or more pairs of first cells and second cells. The first edge score for the identified one or more pairs of first cells and second cells is computed by using a feature vector obtained by concatenating the first set of attributes, the second set of attributes, and the third set of attributes of the one or more pain of first cells and second cells.

The method includes assigning an action to the one or more pairs of first cells and second cells based on the first edge score. The action assigned to the one or more pairs of first cells and second cells comprises a modification in a total tilt and a remote electrical tilt (RET) ofof the antenna for the one or more pairs of first cells and second cells. The system computes a second edge score based on the action assigned to the one or more pairs of first cells and second cells. The method includes calculating an impact of the action assigned to the one or more pairs of first cells and second cells based on the first edge score and a second edge score. The impact of the action assigned to the one or more pairs of first cells and second cells is the difference between the first edge score and the second edge score.

Furthermore, the method includes mitigating the tropospheric interference of the identified one or more pairs of first cells and second cells by configuring a total tilt and a remote electrical tilt (RET) of the antenna for the one or more pairs of first cells and second cells.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components, or circuitry commonly used to implement such components.

FIG. 1 illustrates an exemplary network architecture (100) in which or with which proposed system (110) of the present disclosure can be implemented, in accordance with an embodiment of the present disclosure.

FIG. 2 illustrates an exemplary representation (200) of the system (110), in accordance with an embodiment of the present disclosure.

FIG. 3 illustrates an exemplary method flow diagram (300) depicting a method for facilitating detection and mitigation of interference, in accordance with an embodiment of the present disclosure.

FIG. 4 illustrates an exemplary block diagram (400) of the functional blocks associated with the proposed system, in accordance with an embodiment of the present disclosure.

FIG. 5 illustrates an exemplary block diagram (500) of the functional blocks associated with the ML engine, in accordance with an embodiment of the present disclosure.

FIG. 6 illustrates an exemplary representation (600) of Hepburn data analysis, in accordance with an embodiment of the present disclosure.

FIG. 7 illustrates an exemplary representation (700) of simulation analysis, in accordance with an embodiment of the present disclosure.

FIG. 8 illustrates an exemplary representation (800) of a long-range interference network, in accordance with an embodiment of the present disclosure.

FIG. 9 illustrates an exemplary representation (900) of an aggregate edge count across different iterations of simulation, in accordance with an embodiment of the present disclosure.

FIG. 10 illustrates an exemplary representation (1000) of a flow diagram of Interference Digital Twin Training, in accordance with an embodiment of the present disclosure.

FIG. 11 illustrates an exemplary representation (1100) of a flow diagram of a Simulation Flow of the proposed method, in accordance with an embodiment of the present disclosure.

FIG. 12 illustrates an exemplary computer system (1200) in which or with which embodiments of the present invention can be utilized in accordance with embodiments of the present disclosure.

FIG. 13 illustrates an exemplary method flow chart (1300) depicting a method for mitigating a tropospheric interference for a cell pair in a communication network, in accordance with an embodiment of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting to the invention. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a solution to an entity or an organization with the help of a system and method that mitigates tropospheric interference in a communication network. The system and method can provide a predictive capability for a cell pair having interference if weather and tropospheric information is available at a cell location at a given time. Also, the proposed system and method can identify the cell pairs which have a likelihood of interference and suggest an action for those cell pairs such that the impact will be maximum for the action with minimal impact on coverage. Further, the proposed system and method can also suggest a quantity of tilt values for a cell pair.

Increasing the tilt value for a cell pair can drastically reduce the number of customers who are to be served in a telecommunication area. Therefore, the tilt value for a cell pair has to be increased in a way without affecting the number of customers who can be served in the telecommunication area. A modification of the tilt value for a cell pair to eliminate tropospheric interference without affecting the number of customers to be served may be achieved by a digital twin model. The digital twin model may be a simulation model that may simulate the effect of increasing the tilt value for a cell pair and may determine the tilt value at which the tropospheric interference gets eliminated. It is to be noted that increasing the tilt value for a cell pair may increase the angle of incidence of the antenna of the cell with the tropospheric duct thereby reducing the tropospheric interference. It has been observed from the simulation by the digital twin model that the tilt angle of the antenna of the cell can be increased by only two to three degrees for the elimination of tropospheric interference. Any increase in the tilt angle beyond two to three degrees can greatly reduce the number of customers who may be served in the given telecommunication area.

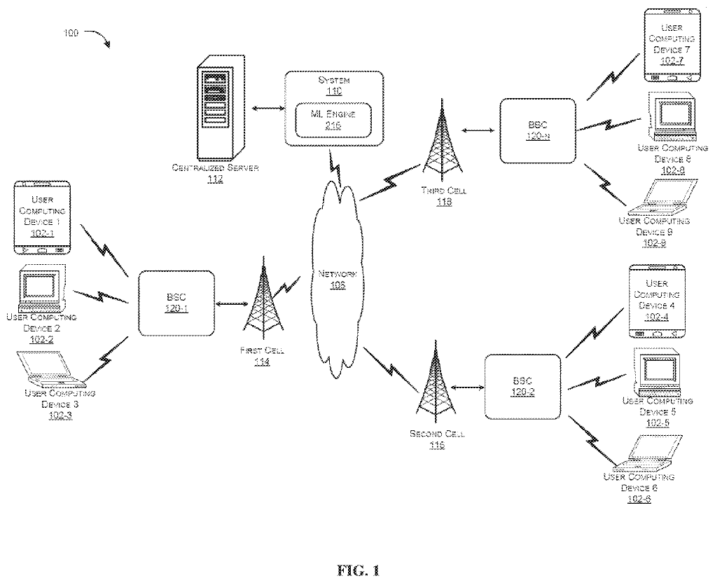

FIG. 1 illustrates an exemplary network architecture (100) in which or with which the system (110) of the present disclosure can be implemented, in accordance with an embodiment of the present disclosure. As illustrated, in an aspect, a plurality of base stations of a plurality of cells in a telecommunication network may be associated with a plurality of user computing devices. In a way of example and not as a limitation, a first base station (120-1) of one or more first cells may be communicatively associated with a plurality of user computing devices (102-1, 102-2.102-3). A second base station (120-2) of one or more second cells may be communicatively associated with a second set of user computing devices (102-4, 102-5, 102-6). A third base station (120-3) of one or more third cells may be communicatively associated with a third set of user computing devices (102-7, 102-8, 102-9) and a fourth base station (120-4) of one or more fourth cells may be communicatively associated with fourth user computing devices and so on. There may be N base stations of one or more cells communicatively associated with N user computing devices in the network architecture (100).

In an exemplary embodiment, the one or more first cells may be aggressor cells and the one or more second cells may be victim cells. In a way of example and not as a limitation, the one or more first cells and the one or more second cells may form a first aggressor-victim pair. The one or more third and the one or more fourth cells can form a second aggressor-victim pair and so on. A person skilled in the art may appreciate that an aggressor-victim pair may be formed in any permutation and combination of an N number of cells present in the telecommunication network.

The plurality of base stations (120-1, 120-2 . . . 120-N) may be further communicatively coupled to a network (106) and at least a centralized server (112). More specifically, the exemplary architecture (100) implements the system (110) equipped with a machine learning (ML) engine (216) for facilitating the detection and mitigation of a tropospheric interference associated with the aggressor-victim pair of cells. The system (110) may be configured to receive a set of data packets from a first cell and a second cell comprising any or a combination of interference data of the first cell and the second cell. The set of data packets may also comprise a strength of interference indicating a strength of a first cell signal being received at the second cell and a date of interference and a time of interference. The system (110) may extract a first set of attributes corresponding to a cell configuration data from the set of data packets received. The system (110) may then extract a second set of attributes corresponding to weather data from the set of data packets received. The Hepburn data may indicate the vulnerability of a particular geographical location to tropospheric interference.

In an exemplary embodiment, the cell configuration data may include a cell configuration parameters such as a total tilt, a remote electrical tilt (RET), a height of a cell tower, a mechanical tilt, a transmission power, a location of the cell tower and the like. Further, the Hepburn data may include a weather data index at a location for a date and a time but not limited to the like.

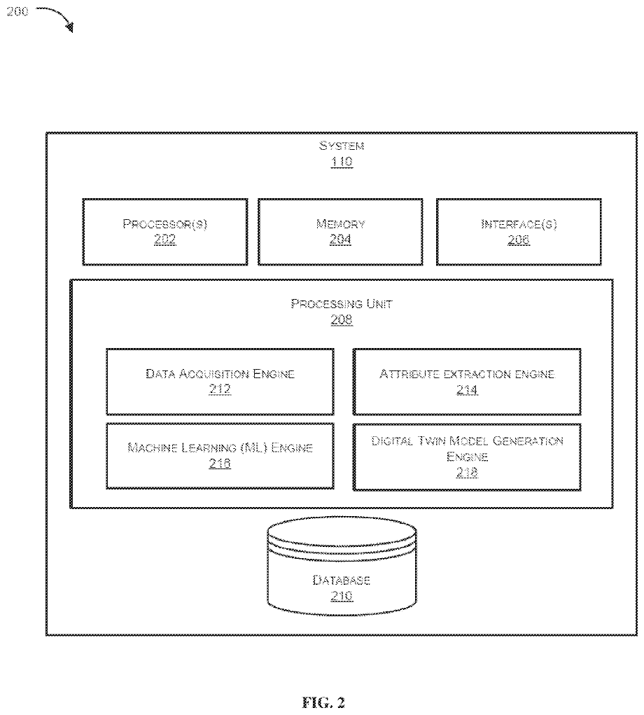

The system (110) may further generate, through the ML engine (216), a trained model corresponding to a digital twin model. The trained model may be configured to determine and predict the tropospheric interference between one or more pairs of first and second cells automatically. Based on the extracted first set of attributes and the second set of attributes, the ML engine (216) (Ref. FIG. 2) may identify one or more pairs of first and second cells that may be affected by the tropospheric interference. The ML engine (216) may compute an edge score for the one or more pairs of first cells and second cells based on the tropospheric interference. Based on the computed edge score, the ML engine (216) may assign an action based on the first set of attributes and the second set of attributes with updated values of configuration to mitigate the tropospheric interference.

In an exemplary embodiment, the digital twin model may be learned using a third set of attributes that may pertain to historical attributes and interference pairs. In another exemplary embodiment, the edge score may be computed based on the first set of attributes, the second set of attributes, and the third set of attributes using the digital twin model.

In an exemplary embodiment, a feature vector may be obtained by looking up the first set of attributes comprising the cell configuration parameters and the edge parameters. A plurality of feature vectors corresponding to an interference data and a non-interference data may be grouped. The plurality of feature vectors may be fed to the digital twin model which provides an edge score. The edge score indicates a likelihood of the tropospheric interference happening between the aggressor-victim pair.

In an embodiment, the computing device (104) and/or the user device (120) may communicate with the system (110) via a set of executable instructions residing on any operating system, including but not limited to. Android™, iOS™, Kai OS™ and the like. In an embodiment, the computing device (104) and/or the user device (120) may include, but not limited to, any electrical, electronic, electro-mechanical or any equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as a touch pad, touch-enabled screen, electronic pen and the like. It may be appreciated that the computing device (104) and/or the user device (120) may not be restricted to the mentioned devices and various other devices may be used. A smart computing device may be one of the appropriate systems for storing data and other private/sensitive information.

In an exemplary embodiment, a network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public switched telephone network (PSTN), a cable network, a cellular network, a satellite network, a fiber-optic network, some combination thereof.

In another exemplary embodiment, the centralized server (112) may include or comprise, by w ay of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the system (110) may include one or more processors (202) coupled with a memory (204). The memory (204) may store instructions that when executed by the one or more processors (202) may cause the system (110) to detect and mitigate the tropospheric interference associated with the aggressor-victim pair of cells. FIG. 2 with reference to FIG. 1, illustrates an exemplary representation of the system (110) for facilitating detection and mitigation of the tropospheric interference associated with the aggressor-victim pair of cells based on a machine learning-based architecture, in accordance with an embodiment of the present disclosure.

In an aspect, the system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute the computer-readable instructions stored in the memory (204) of the system (110). The memory (204) may be configured to store the one or more computer-readable instructions or routines in a non-transitory computer-readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) (206). The interface(s) (206) may comprise a variety of interfaces, for example, interfaces for data input and output devices, referred to as I/O devices, storage devices, and the like. The interface(s) (206) may facilitate communication of the system (110). The interface(s) (206) may also provide a communication pathway for one or more components of the system (110). Examples of such components include, but are not limited to, processing engine(s) (208) and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions.

In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a data acquisition engine (212), an attribute extraction engine (214), a machine learning (ML) engine (216), a digital twin model generation engine (218), and other engines (220). The other engines (220) may include any of a signal processing engine, a prediction engine, and the like.

In an embodiment, the data acquisition engine (212) of the system (110) can receive/process/pre-process the set of data packets from the first cell and the second cell. The set of data packets may include any or a combination of interference data of the first cell and the second cell. The set of data packets may also include a strength of interference indicating a strength of the first cell signal being received at the second cell and the date of interference and the time of interference.

In an embodiment, the attribute extraction engine (214) of the system (110) may extract the first set of attributes corresponding to the cell configuration data from the set of data packets received. Further, the attribute extraction engine (214) may extract the second set of attributes corresponding to the Hepburn data from the set of data packets received from the database (210). The attribute extraction engine (214) of the system (110) may also extract the third set of attributes corresponding to weather data from the set of data packets received from the database (210).

In an embodiment, the ML engine (216) of the system (110) may identify the one or more pairs of first cells and second cells that are affected by the tropospheric interference based on the extracted first attributes and the extracted second attributes. Further, the ML engine (216) of the system (110) may then compute the edge score for the one or more pairs of first cells and second cells. The trained model may be then generated by the digital twin model generation engine (218) corresponding to the digital twin model. The trained model may be configured to determine and predict the tropospheric interference between the one or more first cell and second cell pairs. Based on the first set of attributes and the second set of attributes with updated values, the ML engine (216) may compute the edge score and suggests actions to mitigate the tropospheric interference.

In an exemplary embodiment, the digital twin model may be learned using the first set of attributes, second set of attributes and third set of attributes pertaining to historical attributes, predicted attributes and interference pairs. The edge score may be computed based on the first set of attributes, the second set of attributes, and the third set of attributes using the digital twin model.

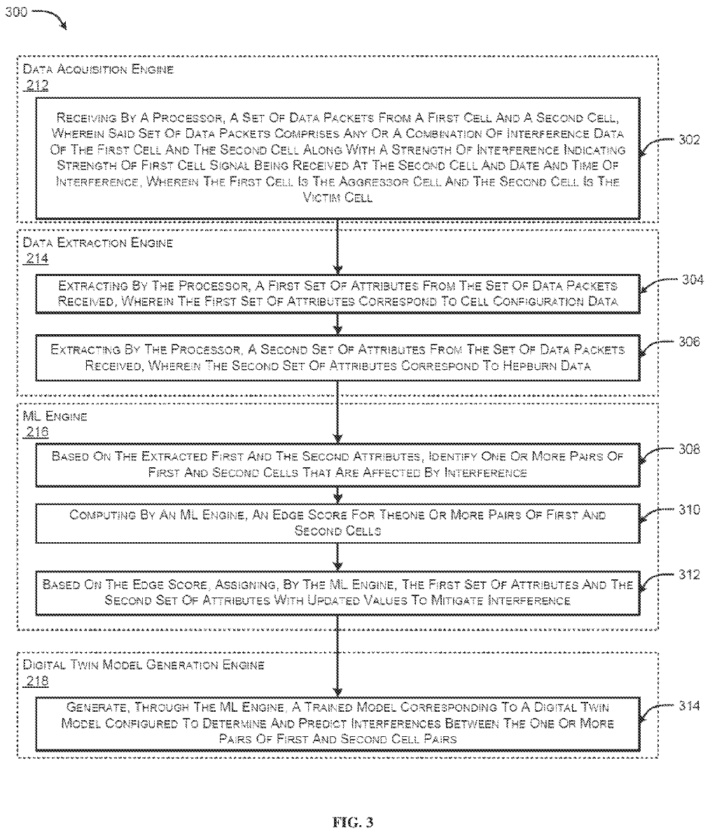

FIG. 3 illustrates an exemplary method flow diagram (300) depicting a method for facilitating detection and mitigation of tropospheric interference associated with the aggressor-victim pair of cells, in accordance with an embodiment of the present disclosure. As illustrated, in an aspect the method may facilitate detection and mitigation of the tropospheric interference associated with the aggressor-victim pair of cells.

The method may include at 302, the step for receiving by the execution of the data acquisition engine (212) by the processor (202), the set of data packets from the first cell and the second cell. The set of data packets may include any or a combination of the interference data of the first cell and the second cell. The set of data packets may also include the strength of interference indicating the strength of the first cell signal being received at the second cell and the date of the tropospheric interference and the time of the tropospheric interference. The first cell may be the aggressor cell and the second cell may be the victim cell. The method may include at 304, the step for extracting, by the execution of attribute extraction engine (214) by the processor (202), the first set of attributes corresponding to the cell configuration data from the set of data packets received. The method may include at 306, the step for extracting by the execution of attribute extraction engine (214) by the processor (202), the second set of attributes corresponding to the Hepburn data from the set of data packets received.

At step 308, the method may include identifying the one or more pairs of first and second cells that are affected by interference, by the execution of the ML Engine (216) by the processor (202). Identifying the one or more pairs of first and second cells that are affected by interference may be based on the extracted first set of attributes and the extracted second set of attributes. The method may include at 310, the step for computing by the execution of the ML engine (216), the edge score for the one or more pairs of first and second cells.

The method may include at 312, the step for generating, by the digital twin model generation engine (218), the trained model corresponding to the digital twin model. The trained model may be configured to determine and predict the tropospheric interference between the one or more pairs of the first and second cell pairs. The method (300) may further include at 314, the step for assigning the edge score and suggesting actions, by the ML engine (216), using the first set of attributes and the second set of attributes with updated values to mitigate the tropospheric interference.

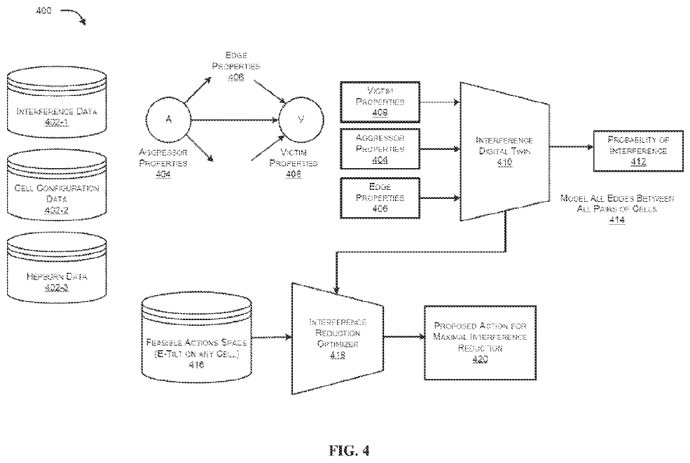

FIG. 4 illustrates an exemplary block diagram (400) of the functional blocks associated with the system (110), in accordance with an embodiment of the present disclosure. As illustrated, in an aspect, given an aggressor-victim pair (a, v), different types of parameters may be extracted for an aggressor cell, a victim cell, and the aggressor-victim pair from at least three different types of data such as the interference data (402-1), the cell configuration data (402-2), and the Hepburn data (402-3). One or more Aggressor Parameters (404) may include parameters such as a total tilt (xₐₜₜ), a remote electrical tilt (RET(xₐᵣₑₜ), a height of an aggressor cell tower (xₐₕ), a height above mean sea level (xₐₐₘₛₗ), azimuth (x_{aazi}), antenna related parameters (xₐₐₙₜ), transmission power (xₐₜₚ) and the like. Hepburn data index at aggressor (xₐₕₑₚ), weather data parameters at the aggressor cell like humidity, and the like. The one or more Aggressor Parameters (404) may be concatenated to form aggressor node properties represented as x_{anode}=[xₐₜₜ, xₐᵣₑₜ, xₐₕ, xₐₐₘₛₗ, x_{aazi}, xₐₐₙₜ, xₐₜₚ, xₐₕₐₚ].

One or more Victim Parameters (408) may include parameters such as a total tilt, a RET, a height of the cell tower, a height above mean sea level, azimuth, antenna-related parameters, transmission power, and the like. The one or more Victim Parameters (408) may be concatenated to form victim node properties represented as x_{vnode}=[xᵥₜₜ, xᵥᵣₑₜ, xᵥₕ, xᵥₐₘₛₗ, x_{vazi}, xᵥₐₙₜ, xᵥₜₚ, xᵥₕₑₚ]

One or more Aggressor-Victim (Edge) parameters (406) may include elements such as
max of total tilt of aggressor total tilt and victim total tilt (xₑₘₐₓₜₜ)
min of total tilt of aggressor total tilt and victim total tilt (xₑₘᵢₙₜₜ)
mean of total tilt of aggressor total tilt and victim total tilt (xₑₘₑₐₙₜₜ)
max of RET between aggressor RET and victim RET (xₑₘₐₓᵣₑₜ)
min of RET between aggressor RET and victim RET (xₑₘᵢₙᵣₑₜ)
mean of RET between aggressor RET and victim RET (xₑₘₑₐₙᵣₑₜ)
max hepburn index between aggressor and victim (xₑₘₐₓₕₑₚ)
min hepburn index between aggressor total tilt and victim total tilt (xₑₘᵢₙₕₑₚ)
mean hepburn index between aggressor total tilt and victim total tilt (xₑₘₑₐₙₜₜ)
a weighted sum of hepburn index values along the path joining aggressor and victim (x_{eweightedhep})
taking cosine and sine of relative direction of aggressor w.r.t victim (x_{eagg cos} x_{eagg sin})
taking cosine and sine of relative direction of victim w.r.t aggressor (x_{evc cos}x_{evic sin})
min and max values of aggressor and victim heights (x_{eaggh}, x_{evich})

In an exemplary embodiment, the one or more Aggressor-Victim (Edge) parameters (406) may be represented as x_{edge}=[xₑₘₐₓₜₜ, xₑₘᵢₙₜₜ, xₑₘₑₐₙₜₜ, xₑₘₐₓᵣₑₜ, xₑₘᵢₙᵣₑₜ, xₑₘₑₐₙᵣₑₜ, xₑₘₐₓₕₑₚ, xₑₘᵢₙₕₑₚ, xₑₘₑₐₙₜₜ, x_{eweightedhep}, x_{eagg cos}, x_{eagg sin}, x_{evic cos}, x_{evic sin}, x_{eaggh}, x_{evich}]

In an exemplary embodiment, the feature vector may be obtained by concatenating the aggressor node properties, the victim node properties, and the aggressor-victim edge properties and may be represented as x_{edge}=[x_{anode},x_{vnode},x_{edge}]. A plurality of feature vectors may be fed to the digital twin model (410) which may provide the edge score. The edge score may indicate the probability or the likelihood of the tropospheric interference (412) happening between the aggressor-victim pair. The tropospheric interference detected by the digital twin model (410) may be reduced by sending the data to the interference reduction optimizer (418) and along with feasible actions space (E-tilt on any cell) (416). The interference reduction optimizer (418) may be configured to provide possible actions for the maximal interference reduction (420). The possible actions for the maximal interference reduction (420) may include a total tilt and a remote electrical tilt (RET) of the antenna for the one or more pairs of first cells and second cells to mitigate the tropospheric interference of the one or more pairs of first cells and second cells.

In an exemplary embodiment, the edge features may include different types of Hepburn features such as:
minimum of hepburn index at aggressor and victim location
maximum of hepburn index at aggressor and victim location
mean of hepburn index at aggressor and victim location
parabolic hepburn index: this is a weighted sum of hepburn index values along the line joining aggressor and victim, weights are proportional to minimum of squared distance of a location to aggressor and victim. Weights used are normalized such that they add up to 1.
Different variations of weighted hepburn values like mean, minimum, maximum, median etc are computed and used as features

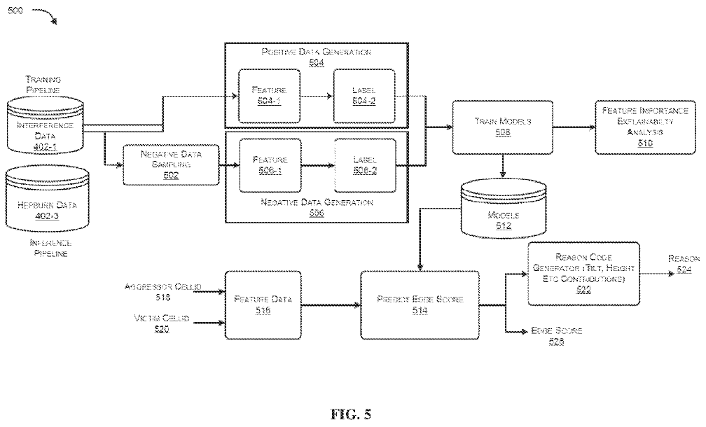

FIG. 5 illustrates an exemplary block diagram (500) of the functional blocks associated with the ML engine (216), in accordance with an embodiment of the present disclosure. As illustrated, with respect to the hepburn data, different types of features may be extracted. The interference data (402-1) may be utilized via a negative data sampling unit (502) to generate a negative data (506) extracting a features for negative data (506-1) and label (506-2). The negative data sampling unit (502) may feed a train model unit (508) with the negative feature (506-1) and the label (506-2) to check on feature importance or explainability analysis (510) and generate models (512). A positive data generation block (504) comprising a positive feature extraction module (504-1) and a label unit (504-2) may directly take the interference data (402-1) for training models at a trained model unit (508). An aggressor cell id (518) and a victim cell id (520) may provide Hepburn data related node features (516) comprising hepburn index values at an aggressor cell location and a victim cell location. The hepburn data related node features (516) may be used to predict the edge score (514), that may be sent to a reason code generator (tilt, height, and the like contributors) (522). The reason code generator (522) may generate reason (524) or determine an actual edge score (526).

In an embodiment, in the model training process, feature vectors corresponding to interference data may be given a label 1 and feature vector corresponding to non-interference data may be given a label 0. Labeled data may be used for learning the digital twin model. Machine learning models and techniques like random forests, gradient boosted trees, neural networks or combination of them may be used for representation and learning of the digital twin model. In a way of example and not as a limitation. Gradient Boosting Algorithm may be used and has been explained herewith. The Gradient Boosting algorithm may use a training set

(xᵢ, yᵢ)₌₁ⁿ differentiable loss function L(y, F(x)) number of iterations M as input.
The Gradient Boosting algorithm may perform the following steps:
1. Initialize model with a constant value: F₀(x)=arg min_{γ}Σᵢ₌₁ⁿL(yᵢ, γ)
2. For m=1 to M:
   a. Compute pseudo residuals.

$${r}_{im} = - {[ \frac{\partial L ( {y}_{i} , F ( {x}_{i} ) )}{\partial F ( {x}_{i} )} ]}_{F ( {x}_{i} ) = {F}_{m - 1} ( {x}_{i} )} for i = 1 , 2 , ... n$$

b. Fit a base learner (or weak learner, e.g. tree) hₘ(x) to pseudo-residuals, i.e. train it using the training set (xᵢ,yᵢ)ᵢ₌₁ⁿ
c. Compute multiplier γₘ(x) by solving the following one-dimensional optimization problem:

$${γ}_{m} ( x ) = {arg min}_{γ} {\sum }_{i = 1}^{n} L ( {y}_{i} , {F}_{m - 1} ( {x}_{i} ) + γ {h}_{m} ( {x}_{i} ) )$$

d. Update the model

Fₘ(x)=Fₘ₋₁(x)+γhₘ(x)
3. Output Fₘ (x)

In an exemplary embodiment, the Model (512) may be trained using an implementation of the Gradient Boosting Algorithm and may be a representation of the digital twin model.

In an exemplary implementation, a summary of interference data and non-interference data in TDD (Time Division Duplex) systems is provided in Table 1. Further, Table 1 provides details regarding region, date, and time related to interference and non-interference data, and other available data points.

TABLE 1
TDD Interference Data Summary

| | |
|---|---|
| Region | North Zone |
| Date | 2021 May 19-2021 May 25 |
| Time Bucket | 08:00, 10:30, 19:30, 22:00 |
| # of data points | 17.15 million |

Non Interference Data Summary

| | |
|---|---|
| Time Bucket | 08:00, 10:30, 19:30, 22:00 |
| # of data points | 17.85 million |

In a way of example but not as a limitation, accuracy for Gradient Boosted Trees as a representation and learning technique to represent digital twin model are provided in Table 2 with one set of parameters where maximum depth is at least 8 and number of trees in gradient boosted trees is at least 50.

TABLE 2
Date: 20121-05-19 to 20121-05-25 Time
Bucket: 08:00, 10:30, 19:30, 22:00

| Hepburn | # of | max | | Time taken |
|---|---|---|---|---|
| Features | trees | depth | Accuracy | [Seconds] |
| 0 | 50 | 8 | 73.33 | 16.12 |
| 1 | 50 | 8 | 76.91 | 1760 |

FIG. 6 illustrates an exemplary representation (600) of Hepburn data analysis, in accordance with an embodiment of the present disclosure. Parabolic Hepburn features are important features for discriminating interference/non-interference edges in the digital twin model. As illustrated, the parabolic curve is given by

$${x}_{parabolic hepburn} = \sum {pw}_{l} * {h}_{l}$$

$${w}_{l} = min ( {d}_{al}^{2} , {d}_{lv}^{2} )$$

$${pw}_{l} = \frac{{w}_{l}}{{\sum }_{l} {w}_{l}}$$

hₗ is hepburn index at location l
dₐₗ is distance of location l from aggressor
dₗᵥ is distance of location l from victim
wₗ is weight of location l shepburn index
pwₗ is parabolic weight of hepburn index at location l

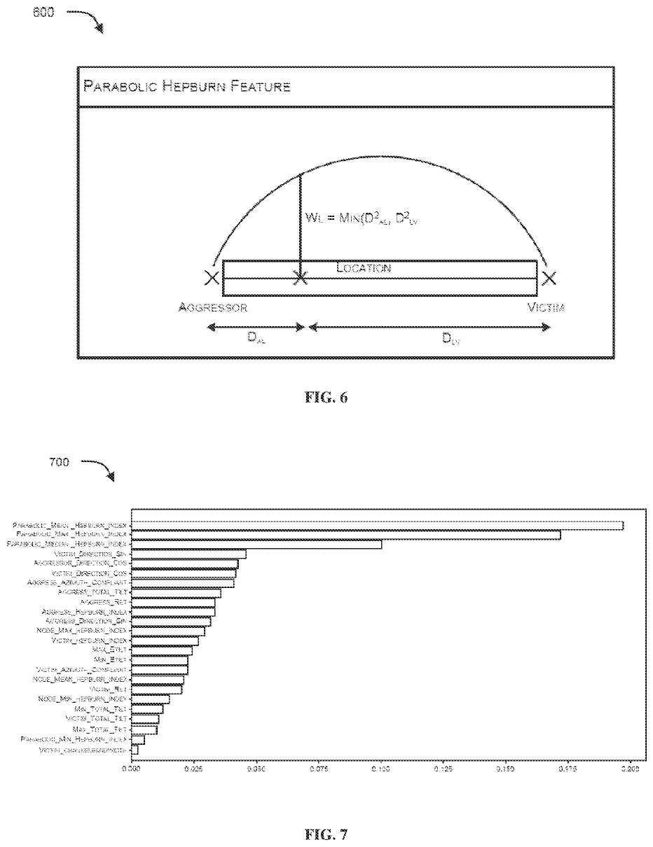

FIG. 7 illustrates an exemplary representation (700) of simulation analysis, in accordance with an embodiment of the present disclosure.

In an embodiment, the simulation may include the steps of identifying aggressor-victim pairs that need to be evaluated and simulating actions on the pairs identified. In a way of example and not as a limitation, the steps required in estimating the impact of actions on a given cell tower using the digital twin model. The action whose impact has been assessed in the simulation process may comprise a modification in the RET value of the aggressor-victim pairs. The simulation analysis may consist of the following steps:
Identifying possible aggressor-victim pairs which need to be evaluated
Extracting the features of the identified aggressor-victim pairs
Computing the edge score of the identified aggressor-victim pairs
Changing RET and total tilt of a cell by 1 degree, keeping other parameters same
Computing the edge score for the identified aggressor-victim pairs based on changes made in the RET and the total tilt of a cell of the aggressor-victim pairs
Measuring a difference between edge scores as an impact of action
Repeating the steps from extracting the features and measuring the difference between the edge scores for all the pairs
Computing an improvement in the edge score for each aggressor cell by aggregating the improvement score across all the aggressor edges
Recomputing the edge score with updated parameters like total tilt and RET and corresponding action is applied on an aggressor which has highest improvement score is selected and
Updating the data and using the updated data and repeating the steps from extracting the features and recomputing with updated parameters are repeated for a fixed number of times or till the required number of actions are obtained

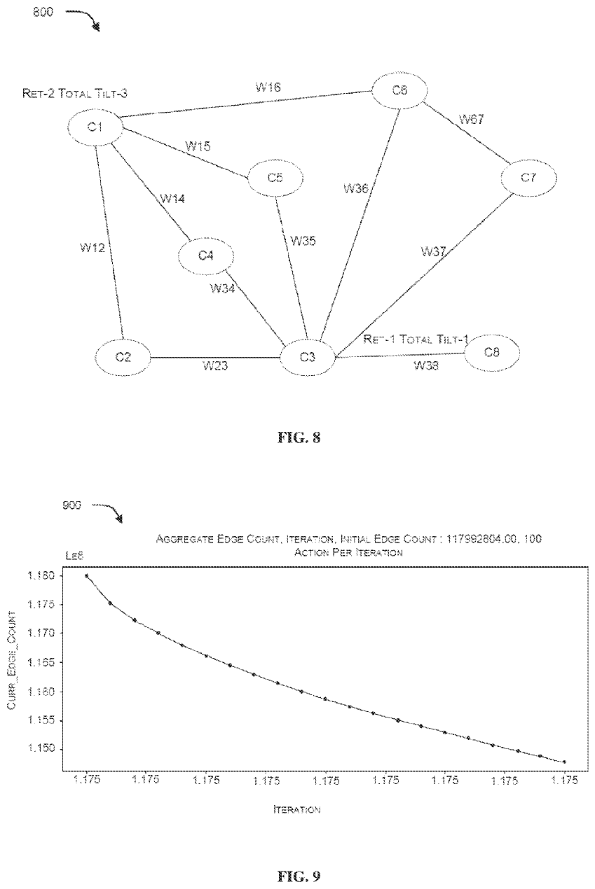

FIG. 8 illustrates an exemplary representation (800) of a long-range interference network, in accordance with an embodiment of the present disclosure. As illustrated, the circles (C1, C2, C3, C4 . . . C8) are cells and the cells connected by arrows are interfering cells. The cell having an outgoing arrow is the aggressor cell (C1, C2, C3, C6) and the cell having an incoming arrow is the victim cell (C4, C5, C7 and C8). The weight on the arrow such as (W16, W14, W15, W12, W23, W35, W34, W36, W37, W38, W67) is the likelihood of the edge having interference. The sum of all the weights on edges may indicate an aggregate edge score based on the configuration of cells in the network.

FIG. 9 illustrates an exemplary representation (900) of an aggregate edge count across different iterations of simulation, in accordance with an embodiment of the present disclosure. Actions are applied to the cells in an iterative manner and impact of actions are measured in terms of the number of edges reduced. FIG. 9 provides an illustration of impact for a simulation run. Y-Axis represents the number of edges and X axis represents number of iterations.

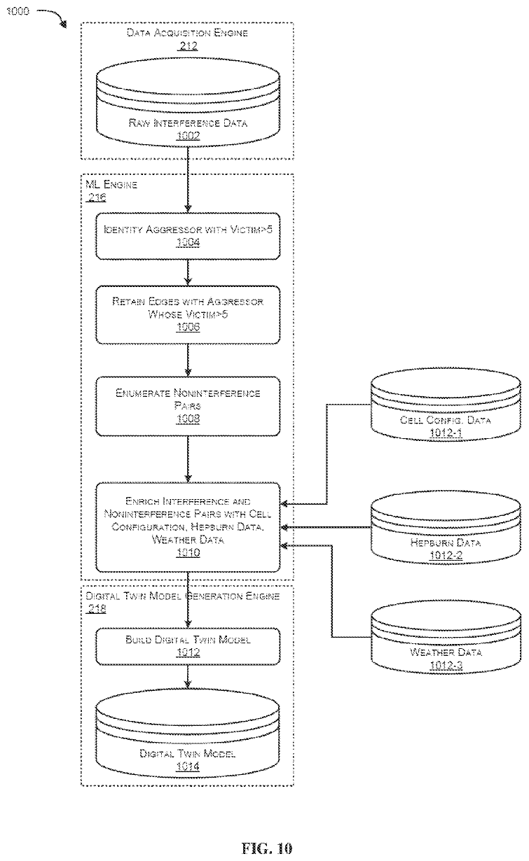

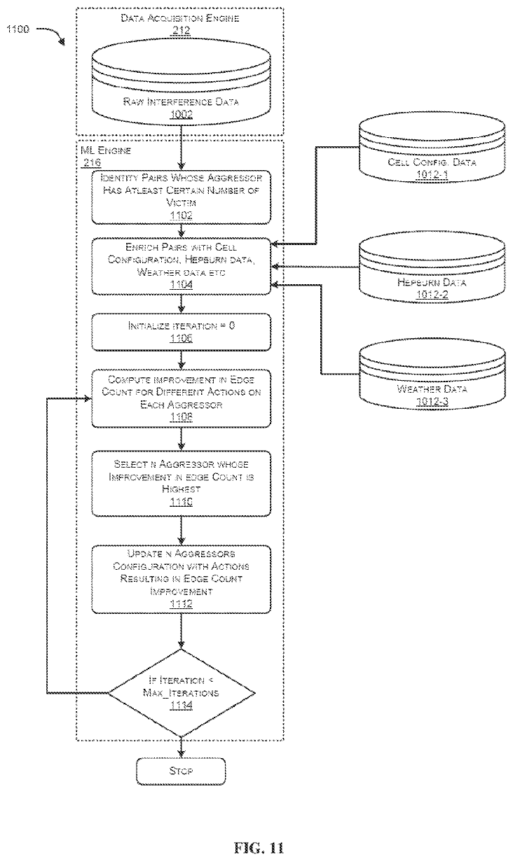

FIG. 10 illustrates an exemplary representation (1000) of a flow diagram of digital twin model training, in accordance with an embodiment of the present disclosure. As illustrated, the flow diagram may include at block 1002, raw interference data received by the data acquisition engine (212). At block 1004, the raw interference data may be used to identify aggressor cells that have more than 5 victim cells. At block 1006, edges may be retained with the aggressor cells that have more than 5 victim cells. At block 1008, non interference cell pairs may be enumerated. At block 1010, both interference and non-interference pairs may be enriched with cell configuration data, Hepburn data, and weather data from cell config data (1012-1), Hepburn data (1012-2), and weather data (1012-3) but not limited to the like. At block 1014, the digital twin model may be built. At block 1016, the digital twin model may be used to mitigate the tropospheric interference of the identified one or more pairs of first cells and second cells by configuring a total tilt and a remote electrical tilt (RET) of the antenna for the one or more pairs of first cells and second cells.

FIG. 11 illustrates an exemplary representation (1100) of a flow diagram of a simulation flow of the proposed method, in accordance with an embodiment of the present disclosure. As illustrated, the simulation flow diagram may include at block 1002, raw interference data being received by the data acquisition engine (212). At block 1102, the ML Engine (216) may identify cell pairs whose aggressor has a certain number of victims. At block 1104, the cell pairs may be enriched with cell configuration data, Hepburn data, weather data, and the like from cell config data (1012-1), Hepburn data (1012-2), and weather data (1012-3) but not limited to the like. At block 1106, the iteration may be initialized to 0. At each iteration, at block 1108, an improvement in edge count may be computed for different actions on each aggressor. At block 1110, an aggressor whose improvement in edge count is the highest may be selected. At block 1112, an N aggressors configuration may be updated with actions resulting in an edge count improvement. If at block 1114, the number of iterations is less than a maximum number of iterations, then the loop from the block 1108 to the block 1114 may be repeated. If at block 1114, the number of iterations is greater than or equal to a maximum number of iterations then the process may be stopped.

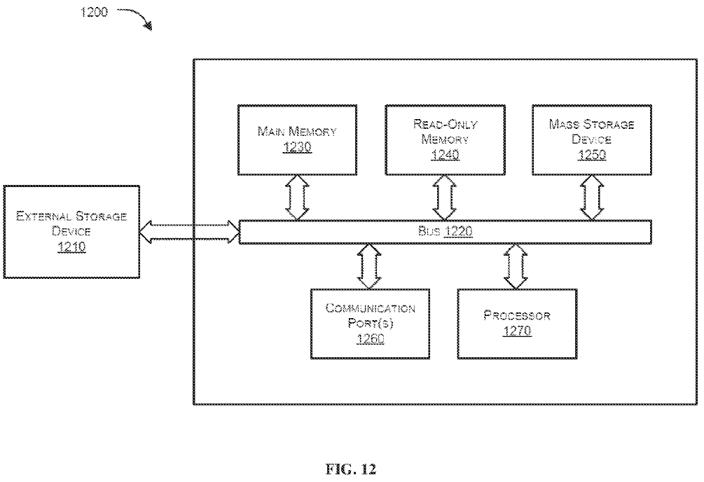

FIG. 12 illustrates an exemplary computer system (1200) in which or with which embodiments of the present invention can be utilized in accordance with embodiments of the present disclosure. As shown in FIG. 12, the computer system (1200) can include an external storage device (1210), a bus (1220), a main memory (1230), a read-only memory (1240), a mass storage device (1270), a communication port (1260), and a processor (1270). A person skilled in the art will appreciate that the computer system (1200) may include mom than one processor (1270) and communication ports (1260). Examples of the processor (1270) include, but are not limited to, an Intel® Itanium® or Itanium 2 processor(s), or AMD® Opteron® or Athlon MP® processor(s), Motorola® lines of processors, FortiSOC™ system on chip processors or other future processors. Processor (1270) may include various modules associated with embodiments of the present invention. The communication port (1260) can be any of an RS-232 port for use with a modem-based dialup connection, a 10/100 Ethernet port, a Gigabit, or 12 Gigabit port using copper or fiber, a serial port, a parallel port, or other existing or future ports. The communication port (1260) may be chosen depending on a network, such as a Local Area Network (LAN), Wide Area Network (WAN), or any network to which the computer system (1200) connects. The memory (1230) can be Random Access Memory (RAM), or any other dynamic storage device commonly known in the art. The read-only memory (1240) can be any static storage device(s) e.g., but not limited to, a Programmable Read-Only Memory (PROM) chips for storing static information e.g., start-up or BIOS instructions for the processor (1270). The mass storage (1250) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7122 family) or Hitachi (e.g., the Hitachi Deskstar 7K1200), one or more optical discs, Redundant Array of Independent Disks (RAID) storage, e.g. an array of disks (e.g., SATA arrays), available from various vendors.

The bus (1220) communicatively couples the processor(s) (1270) with the other memory, storage, and communication blocks. The bus (1220) can be, e.g. a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor (1270) to the computer system (1200).

Optionally, operator and administrative interfaces, e.g. a display, keyboard, joystick and a cursor control device, may also be coupled to the bus (1220) to support direct operator interaction with a computer system. Other operator and administrative interfaces can be provided through network connections connected through the communication port (1260). The external storage device (1212) can be any kind of external harddrives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

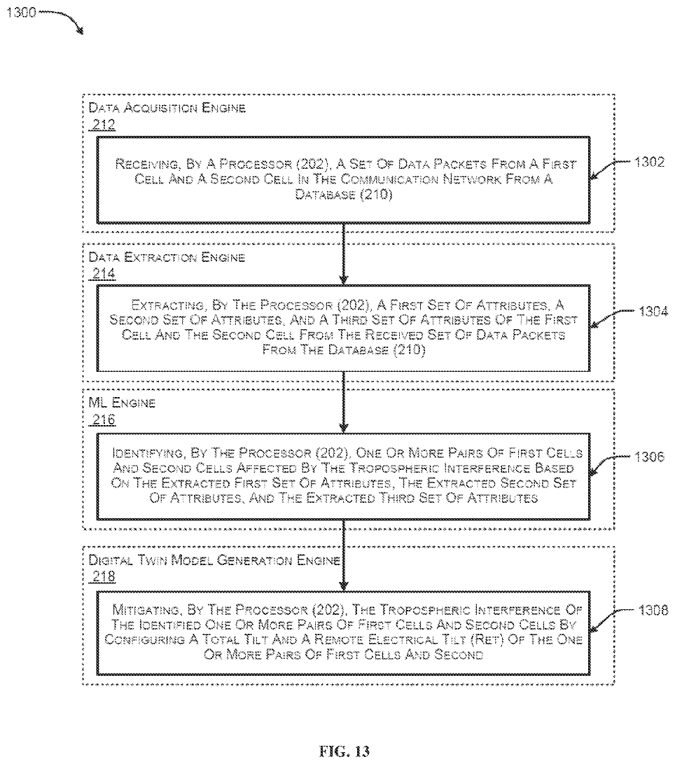

FIG. 13 illustrates exemplary method flow chart (1300) depicting a method for signature based verification of an executable set of instructions prior to execution, in accordance with an embodiment of the present disclosure. The method (900) may be described in the general context of computer-executable instructions. Generally, computer-executable instructions can include routines, programs, objects, components, data structures, procedures, modules, and functions, which perform functions or implement abstract data types.

The order in which the method (1300) is described is not intended to be construed as a limitation, and any number of the described method blocks can be combined in any order to implement the method (1300). Additionally, individual blocks may be deleted from the methods without departing from the scope of the subject matter described herein. Furthermore, the method (1300) can be implemented in any suitable hardware, software, firmware, or combination thereof.

At block (1302), the method may include receiving, by the data acquisition engine (212) of the processor (202), a set of data packets from a first cell and a second cell in the communication network. The set of data packets comprises any or a combination of the tropospheric interference data of the one or more pairs of first cells and second cells, a strength of the tropospheric interference indicating strength of a first cell signal being received at a second cell, a date of the tropospheric interference, and a time of the tropospheric interference.

At block (1304), the method may include extracting, by the attribute extraction engine (214) of the processor (202), the first set of attributes, the second set of attributes, and the third set of attributes of the first cell and the second cell from the received set of data packets. The first set of attributes corresponds to the cell configuration data that comprises the total tilt, the remote electrical tilt (RET), the height of a cell tower, the mechanical tilt, the transmission power, and the location of a cell tower. The second set of attributes corresponds to weather data that comprises a weather data index at a location of a cell tower for a given cell at a given date and a given time and Hepburn indices on the area joining first cell and second cell in a pair. The third set of attributes corresponds to the weather data.

At block (1306), the method may include identifying, by the ML engine (216) of the processor (202), one or more pairs of first cells and second cells affected by the tropospheric interference based on the extracted first set of attributes, the extracted second set of attributes, and the extracted third set of attributes. The processor (202) further computes a first edge score for the identified one or more pairs of first cells and second cells based on the extracted first set of attributes, the extracted second set of attributes, and the extracted third set of attributes. The first edge score for the identified one or more pairs of first cells and second cells indicates a likelihood of the tropospheric interference between the one or more pairs of first cells and second cells. The first edge score for the identified one or more pairs of first cells and second cells is computed by using a feature vector obtained by concatenating the first set of attributes, the second set of attributes, and the third set of attributes of the one or more pairs of first cells and second cells. The processor (202) assigns an action to the one or more pairs of first cells and second cells based on the first edge score. The action assigned to the one or more pairs of first cells and second cells comprises a modification in a total tilt and a remote electrical tilt (RET) of the antenna for the one or more pairs of first cells and second cells. The processor (202) computes a second edge score based on the action assigned to the one or more pairs of first cells and second cells. The processor (202) calculates an impact of the action assigned to the one or more pairs of first cells and second cells based on the first edge score and a second edge score. The impact of the action assigned to the one or more pairs of first cells and second cells is the difference between the first edge score and the second edge score.

At block (1308), the method may include mitigating, by the processor (202), the tropospheric interference of the identified one or more pairs of first cells and second cells by configuring a total tilt and a remote electrical tilt (RET) of the antenna for the one or more pairs of first cells and second.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides a method and system for modeling a digital twin for long-range tropospheric interference mitigation using Gradient boosted Trees and Actions but not limited to the like to provide Remote electrical tilt changes. Different modeling techniques can be used for the digital twin model such as random forests, neural networks, and deep learning techniques. Different actions can be considered like a change of height, mechanical tilt, azimuth, and the like. With this unique solution provided in the disclosure, cells that cause long-range interference can be pre-empted to mitigate the tropospheric interference by taking actions like increasing remote electrical tilt, height, azimuth mechanical tilt, and the like.

The present disclosure provides a method and system for improving network performance by mitigating tropospheric interference for one or more pairs of first cells and second cells.

The present disclosure provides a method and system for predicting the likelihood of tropospheric interference by calculating an edge score of the one or more pairs of first cells and second cells based on the attributes of the one or more pairs of first cells and second cells to mitigate tropospheric interference and improve network performance.

The present disclosure provides a method and system for identifying actions with minimal impact on coverage and suggesting a quantity of tilt values for each cell to mitigate tropospheric interference.

### RESERVATION OF RIGHTS

A portion of the disclosure of this patent document contains material, which is subject to intellectual property rights such as but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. The present disclosure may pertain to 3GPP specifications, such as 3GPP TS 36.211 version 12.9.0 Release 12.

We claim:

1. A system for mitigating tropospheric interference in a communication network, the system comprising:
a processor (202);
a memory (204) coupled to the processor (202), wherein the memory (204) comprises processor-executable instructions, which on execution, causes the processor to:
receive a set of data packets from a first cell and a second cell in the communication network from a database (210);
extract a first set of attributes, a second set of attributes, and a third set of attributes of the first cell and the second cell from the received set of data packets from the database (210);
identify one or more pairs of first cells and second cells affected by the tropospheric interference based on the extracted first set of attributes, the extracted second set of attributes, and the extracted third set of attributes; and
mitigate the tropospheric interference of the identified one or more pairs of first cells and second cells by configuring a total tilt and a remote electrical tilt (RET) for the one or more pairs of first cells and second cells.

2. The system as claimed in claim 1, wherein the set of data packets comprises any or a combination of a tropospheric interference data of the one or more pairs of first cells and second cells, a strength of the tropospheric interference indicating strength of a first cell signal being received at a second cell, a date of the tropospheric interference, and a time of the tropospheric interference.

3. The system as claimed in claim 1, wherein the first set of attributes correspond to cell configuration data that comprises a total tilt, a remote electrical tilt (RET), a height of a cell tower, a mechanical tilt, a transmission power, and a location of a cell tower.

4. The system as claimed in claim 1, wherein the second set of attributes corresponds to Hepburn data that comprises a weather data index at a location of a cell tower for a given cell on a given date and a given time and Hepburn indices on the area joining first cell and second cell in a pair.

5. The system as claimed in claim 1, wherein the third set of attributes corresponds to weather data.

6. The system as claimed in claim 1, wherein the processor-executable instructions, on execution, further causes the processor (202) to compute a first edge score for the identified one or more pairs of first cells and second cells based on the extracted first set of attributes, the extracted second set of attributes, and the extracted third set of attributes.

7. The system as claimed in claim 6, wherein the first edge score for the identified one or more pairs of first cells and second cells indicates a likelihood of the tropospheric interference between the one or more pairs of first cells and second cells.

8. The system as claimed in claim 6, wherein the first edge score for the identified one or more pairs of first cells and second cells is computed by using a feature vector obtained by concatenating the first set of attributes, the second set of attributes, and the third set of attributes of the one or more pairs of first cells and second cells.

9. The system as claimed in claim 6, wherein the processor-executable instructions, on execution, further causes the processor (202) to assign an action to the one or more pairs of first cells and second cells based on the first edge score.

10. The system as claimed in claim 9, wherein the action assigned to the one or more pairs of first cells and second cells comprises a modification in a total tilt and a remote electrical tilt (RET) for the one or more pairs of first cells and second cells.

11. The system as claimed in claim 9, wherein the processor-executable instructions, on execution, further cause the processor (202) to compute a second edge score based on the action assigned to the one or more pairs of first cells and second cells.

12. The system as claimed in claim 9, wherein the processor-executable instructions, on execution, further cause the processor (202) to calculate an impact of the action assigned to the one or more pairs of first cells and second cells based on the first edge score and a second edge score.

13. The system as claimed in claim 12, wherein the impact of the action assigned to the one or more pairs of first cells and second cells is the difference between the first edge score and the second edge score.

14. A method for mitigating tropospheric interference in a communication network, the method comprising:
receiving, by a processor (202), a set of data packets from a first cell and a second cell in the communication network from a database (210);
extracting, by the processor (202), a first set of attributes, a second set of attributes, and a third set of attributes of the first cell and the second cell from the received set of data packets from the database (210);
identifying, by the processor (202), one or more pairs of first cells and second cells affected by the tropospheric interference based on the extracted first set of attributes, the extracted second set of attributes, and the extracted third set of attributes;
mitigating, by the processor (202), the tropospheric interference of the identified one or more pairs of first cells and second cells by configuring a total tilt and a remote electrical tilt (RET) for the one or more pairs of first cells and second.

15. The method as claimed in claim 14, wherein the set of data packets comprises any or a combination of a tropospheric interference data of the one or more pairs of first cells and second cells, a strength of the tropospheric interference indicating strength of a first cell signal being received at a second cell, a date of the tropospheric interference, and a time of the tropospheric interference.

16. The method as claimed in claim 14, wherein the first set of attributes corresponds to a cell configuration data that comprises a total tilt, a remote electrical tilt (RET), a height of a cell tower, a mechanical tilt, a transmission power, and a location of a cell tower.

17. The method as claimed in claim 14, wherein the second set of attributes corresponds to Hepburn data that comprises a weather data index at a location of a cell tower for a given cell at a given date and a given time and Hepburn indices on the area joining first cell and second cell in a pair.

18. The method as claimed in claim 14, wherein the third set of attributes corresponds to a weather data.

19. The method as claimed in claim 14, wherein the processor (202) further computes a first edge score for the identified one or more pairs of first cells and second cells based on the extracted first set of attributes, the extracted second set of attributes, and the extracted third set of attributes.

20. The method as claimed in claim 19, wherein the first edge score for the identified one or more pairs of first cells and second cells indicates a likelihood of the tropospheric interference between the one or more pairs of first cells and second cells.

21. The method as claimed in claim 19, wherein the first edge score for the identified one or more pairs of first cells and second cells is computed by using a feature vector obtained by concatenating the first set of attributes, the second set of attributes, and the third set of attributes of the one or more pairs of first cells and second cells.

22. The method as claimed in claim 19, wherein the processor (202) assigns an action to the one or more pairs of first cells and second cells based on the first edge score.

23. The method as claimed in claim 22, wherein the action assigned to the one or more pairs of first cells and second cells comprises a modification in a total tilt and a remote electrical tilt (RET) for the one or more pairs of first cells and second cells.

24. The method as claimed in claim 22, wherein the processor (202) computes a second edge score based on the action assigned to the one or more pairs of first cells and second cells.

25. The method as claimed in claim 22, wherein the processor (202) calculates an impact of the action assigned to the one or more pairs of first cells and second cells based on the first edge score and a second edge score.

26. The method as claimed in claim 25, wherein the impact of the action assigned to the one or more pairs of first cells and second cells is the difference between the first edge score and the second edge score.
